(19) United States
(12) Patent Application Publication
(10) Pub. No.: US 2007/0078546 A1
(43) Pub. Date: Apr. 5, 2007

(54) SOUND OUTPUT SYSTEM AND METHOD

(75) Inventors: Kuan-Hong Hsieh, Shenzhen (CN); Han-Che Wang, Shenzhen (CN); Shin-Hong Chung, Shenzhen (CN); Wen-Chuan Lian, Shenzhen (CN); Xiao-Guang Li, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,412

(22) Filed: Aug. 4, 2006

(30) Foreign Application Priority Data
Sep. 23, 2005 (CN) 200510037483.3

(51) Int. Cl. G06F 17/00

(52) U.S. Cl. 700/94

(57) ABSTRACT

A sound output system is provides. The system includes one or more sound output apparatuses, each sound output apparatus having been assigned an identification (ID) code; a server for storing the ID code and corresponding compensation parameters for each sound output apparatus; and an audio signal generating device, connected to the server through a network. The audio signal generating device includes a compensation parameter obtaining module for obtaining the ID code of a sound output apparatus if the sound output apparatus is connected to the audio signal generating device, and downloading compensation parameters corresponding to the ID code from the server; and a compensation unit for regulating audio signals according to the compensation parameters, and outputting the regulated audio signals to the sound output apparatus via an interface. Another sound output method is also provided.

### CROSS-REFERENCES TO RELATED APPLICATION

This application is incorporated with U.S. patent application Ser. No. 11/173,130 entitled “sound outputting apparatus having compensation characteristics,” filed on Jul. 1, 2005 herein by reference.

### TECHNICAL FIELD

The present invention relates to sound output systems and methods, and particularly to a sound output system and method having compensation characteristics.

### GENERAL BACKGROUND

Today, we often listen to a portable device, such as an audio signal generating device, via an earphone. For best listening pleasure, a user need an earphone that turns audio signals into high fidelity sound.

Humans voices and various musical sounds are various signals having complicated waveforms. The frequency of sound audible to the human ear is generally in the range from 20 Hz to 20 KHz. The frequency range of speech is mainly from 150 Hz to 4 KHz, and the frequency range of musical sound is mainly from 40 Hz to 18 KHz. The energy of the human voice is mostly distributed in the frequency range of 200 Hz-35 KHz. Therefore, in order to correctly play such a wide variety of signals and obtain high quality timbre, an earphone is required to have a wide frequency response characteristic, adequate sound pressure levels, and a large dynamic range. Further, an earphone is also desired to attain a perfect frequency-efficiency characteristic and a perfect frequency-phase delay characteristic. If this is achieved, the output of the earphone maintains high power efficiency and low phase leads or delays as compared to the input of the earphone, accordingly, a listener will hear sounds in high quality timbre. In the following description, phase leads and phase delays are collectively referred to simply as phase delays.

A conventional earphone typically has a frequency-efficiency characteristic and a frequency-phase delay characteristic. These characteristics typically cause much deviation of the output of the earphone from the input of the earphone. That is, the real output is far from an ideal output, and results in poor timbre.

To solve such problem, what is needed is a sound output system and method which have correcting characteristic.

### SUMMARY

A sound output system is provided. The sound output system one or more sound output apparatuses, each sound output apparatus having been assigned an identification (ID) code; a server for storing the ID code and corresponding compensation parameters for each sound output apparatus; and an audio signal generating device connected to the server through a network. The audio signal generating device includes a compensation parameter obtaining module for obtaining a ID code of a sound output apparatus if the sound output apparatus is connected to the audio signal generating device, and downloading compensation parameters corresponding to the ID code from the server; and a compensation unit for regulating audio signals according to the compensation parameters, and outputting the regulated audio signals to the sound output apparatus via an interface.

A sound output method is also provided. The sound output method includes the steps of: (a) providing one or more sound output apparatuses, an audio signal generating device for outputting audio signals, and a server; (b) obtaining an identification (ID) code of a sound output apparatus if the sound output apparatus is connected to the audio signal generating device, and downloads compensation parameters corresponding to the ID code from the server; (c) regulating the audio signals according to the compensation parameters; and (d) outputting the regulated audio signals to the sound output apparatus via an interface.

An audio signal generating device is further provided. The audio signal generating device can be connected to an external server through a network, and includes a compensation parameter obtaining module for obtaining an identification (ID) code of an external sound output apparatus if the sound output apparatus is connected thereto, and downloading compensation parameters corresponding to the ID code from the server; and a compensation unit for regulating audio signals according to the compensation parameters, and outputting the regulated audio signals to the sound output apparatus via an interface.

Other advantages and novel features will become more apparent from the following detailed description when taken in conjunction with the accompanying drawings, in which:

### BRIEF DESCRIPTION OF DRAWINGS

FIG. 1 is a block diagram of a sound output system in accordance with a first preferred embodiment of the present invention;

FIG. 2 is a flowchart of a first preferred sound output method by implementing the system in FIG. 1;

FIG. 3 is a block diagram of a sound output system in accordance with a second preferred embodiment of the present invention; and

FIG. 4 is a flowchart of a second preferred sound output method by implementing the system in FIG. 2.

### DETAILED DESCRIPTION OF THE PREFERRED EMBODIMENT

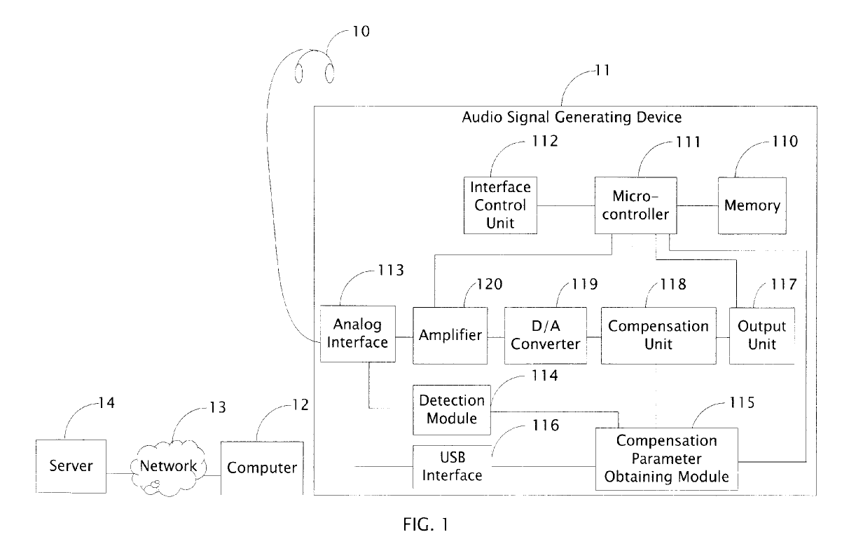

FIG. 1 is a block diagram of a sound output system in accordance with a first preferred embodiment of the present invention. The sound output system mainly includes one or more earphones 10 (only one shown), an audio signal generating device 11, and a server 14. The earphone 10 can be substituted by any other sound output apparatus that can transform audio signals into sounds, such as a speaker or the like. The audio signal generating device 11 may be an MP3 player, a CD player, a computer, and so on. In the preferred embodiment, the audio signal generating device 11 takes an MP3 player as an example.

The audio signal generating device 11 can be connected to a computer 12. The computer 12 is connected to a server 14 through a network 13. Accordingly, the audio signal generating device 11 is connected to the server 14 via the computer 12.

Each earphone 10, having been assigned an identification (ID) code, is capable of transforming audio signals in a preset frequency range into sounds having corresponding sound pressure levels.

Each earphone 10 has real characteristics per se, including but not limited to a real frequency-efficiency characteristic and a real frequency-phase delay characteristic. The real characteristics cause real outputs of the earphone 10 to deviate from ideal outputs of the earphone 10, thereby resulting in distortions of the outputs. In order to prevent the distortions, compensation parameters thereupon are introduced and provided in the server 14. The compensation parameters include a frequency-efficiency compensation parameter and a frequency-phase delay compensation parameter. Each of the compensation parameters is derived from a testing system (not shown) according to corresponding real characteristics of the earphone 10, and is adapted to minimize or even eliminate deviations between uncompensated real outputs and ideal outputs of the earphone 10. Building principles of the compensation parameters refer to U.S. patent application Ser. No. 11/173,130. In addition, the server 14 further stores an ID code of each earphone 10 corresponding to compensation parameters.

The audio signal generating device 11 includes a memory 110, a microcontroller 111, interface control unit 112, an analog interface 113, a detection module 114, a compensation parameter obtaining module 115, an output unit 117, a compensation module 118, a digital/analog (D/A) converter 119, and an amplifier 120.

The memory 110 is for storing the ID code of the earphone 110 that is last connected to the audio signal generating device 11. When the earphone 10 is first connected to the audio signal generating device 11, the audio signal generating device 11 receives the ID code of the earphone 10 from an operational input, and downloads compensation parameters corresponding to the ID code from the server 14 via the computer 12, and further stores the ID code and the corresponding compensation parameters in the memory 110.

The detection module 114 detects whether the analog interface 113 is connected to the earphone 10. If so, the audio signal generating device 11 displays a dialog box prompting a user to input the ID code of the earphone 10, and receives the ID code input. Whereupon, the micro-controller 111 determines whether the ID code is the same as the ID code stored in the memory 110. If the ID code of the earphone 10 is different from the displayed ID code, the audio signal generating device 11 displays a prompt information for a connection to the computer 12, and then the compensation parameter obtaining module 115 is thereupon connected to the computer 12 via a universal serial bus (USB) interface 116, thereby being further connected to the server 14. The compensation parameter obtaining module 115 transmits the ID code of the earphone 10 to the server 14. The server 14 transmits compensation parameters corresponding to the ID code to the compensation parameter obtaining module 115. The compensation parameter obtaining module 115 stores the ID code and the corresponding compensation parameters in the memory 110.

The micro-controller 11 is provided for controlling the output unit 117, the compensation unit 118, and the amplifier 120 to perform a corresponding operation. The memory 110 is connected to the microcontroller 111, and further stores audio files and video files. if the interface control unit 112 receives a play operation, the micro-controller 11 controls the output unit 117 to read audio files stored in the memory 110 and outputs corresponding audio signals, the compensation unit 118 regulates the audio signals according to the compensation parameters, so as to approach or even attain ideal outputs of the earphone 10, and transmits the regulated audio signals to the D/A converter 119. The D/A converter 119 converts the regulated audio signals into analog audio signals. The amplifier 120 amplifies the analog audio signals, and outputs the amplified analog audio signals to the earphone 10 via the analog interface 113. Thereupon, the earphone 10 transforms the amplified analog audio signals into sounds, and outputs the sounds. The interface control unit 112 is further used for receiving another operational inputs for adjusting volume.

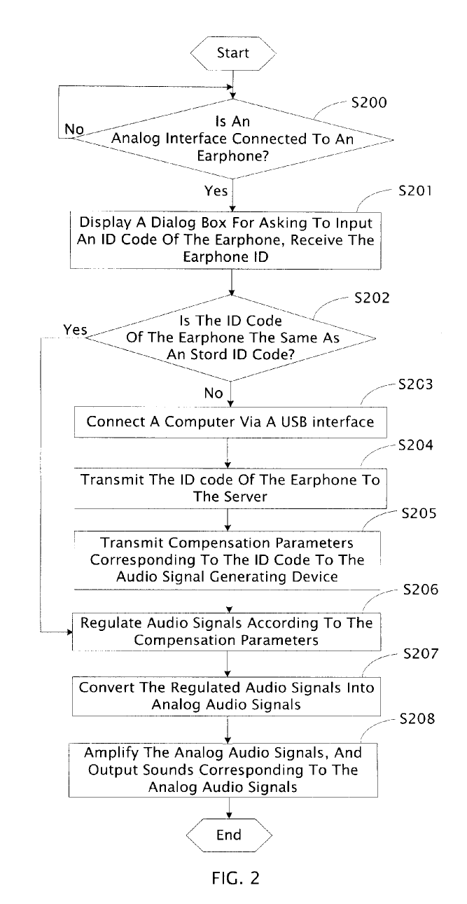

FIG. 2 is a flowchart of a first preferred sound output method by implementing the system of FIG. 1. In step S200, the detection module 114 detects whether the analog interface 113 is connected to the earphone 10. If the analog interface 113 is not connected to the earphone 10, the procedure repeats S200. Otherwise, in step S201, the audio signal generating device 11 displays a dialog box prompting a user to input the ID code of the earphone 10, and receives the ID code input. In step S202, the micro-controller whether the ID code of the earphone 10 is the same as the ID code stored in the memory 110. If the ID code of the earphone 10 is different from the ID code stored in the memory 110, in step S203, the audio signal generating device 11 displays a prompt information for a connection to a computer 12. The compensation parameter obtaining module 115 is then connected to the computer 12 via the USB interface 116, thereby establishing a connection to the server 14. In step S204, the compensation parameter obtaining module 115 transmits the ID code of the earphone 10 to the server 14. In step S205, the server 14 transmits the compensation parameters corresponding to the ID code to the audio signal generating device 11, the audio signal generating device 11 stores the ID code and the corresponding compensation parameters in the memory 110. In step S206, the compensation unit 118 regulates audio signals output by the output unit 117 according to the downloaded compensation parameters, so as to approach or even attain the ideal output of the earphone 1, and transmits the regulated audio signals to the D/A converter 119.

In above-described step S202, if the ID code of the earphone 10 is the same as the ID code stored in memory, the procedures goes directly to step S206 described above, the compensation unit 118 regulates audio signals output by the output unit 117 according to the stored compensation parameters, and transmits the regulated audio signals to the D/A converter 119.

In step S207, the D/A converter 119 converts the regulated audio signals into analog audio signals. In step S208, the amplifier 120 amplifies the analog audio signals, and outputs the amplified analog audio signals to the earphone 10 via the analog interface 113, thereupon the earphone 10 outputs corresponding sounds.

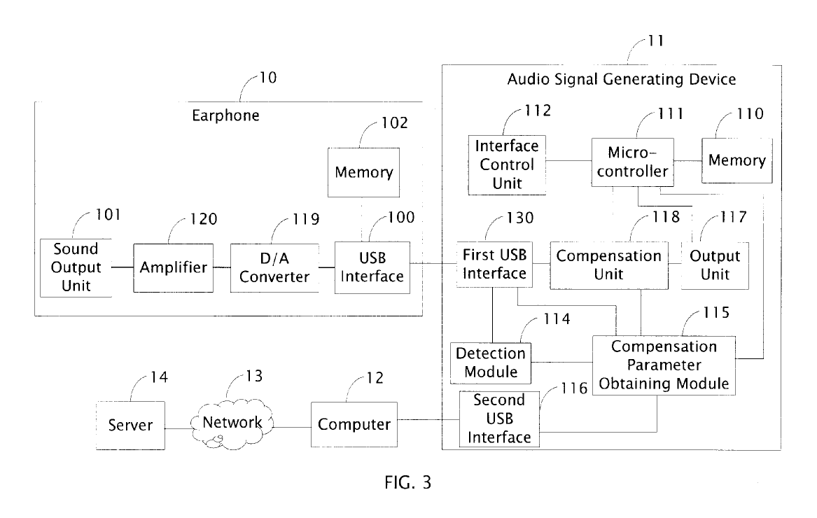

FIG. 3 is a block diagram of a sound output system in accordance with a second preferred embodiment of the present invention. The sound output system of the second preferred embodiment is the same as that of the first preferred embodiment, except that the digital/analog (D/A) 119 and the amplifier 120 is included in the earphone 10 instead of the audio signal generating device 11. The earphone 10 further includes a universal serial bus (USB) interface 100, a sound output unit 101, and a memory 102. The audio signal generating device 11 further includes a first USB interface 130 substituting for the analog interface 113, a second USB interface 116 equaling to the USB interface 116 of the first preferred embodiment.

The memory 102 stores the ID code of the earphone 10. The first USB interface 130 is connected to the detection module 114, the compensation parameter obtaining module 115, and the compensation module 118. The second USB interface 116 is connected with the compensation parameter obtaining module 115, and could be connected to a computer 12.

The memory 110 is for storing the ID code of the earphone 110 last connected to the audio signal generating device 11. When the earphone 10 is first connected to the audio signal generating device 11, the audio signal generating device 11 obtains the ID code of the earphone 10 from the memory 102, and downloads compensation parameters corresponding to the ID code from the server 14 via the computer 12, and further stores the ID code and the corresponding compensation parameters in the memory 110.

The detection module 114 detects whether the first USB interface 130 is connected to an earphone 10. If so, the detection module 114 obtains an ID code of the earphone 10 in the memory 102 via the first USB interface 130, and determines whether the ID code of the earphone 10 is the same as the ID code stored in the memory 110. If the ID code of the earphone 10 is different from the ID code stored in the memory 110, the audio signal generating device 11 displays a prompt information for the connection to a computer 12. The compensation parameter obtaining module 115 is thereupon connected to the computer 12 via the second USB interface 116, thereby establishing the connection with the server 14. The compensation parameter obtaining module 115 transmits the ID code of the earphone 10 to the server 14. The server 14 transmits compensation parameters corresponding to the ID code to the compensation parameter obtaining module 115, thereupon the compensation parameter obtaining module 115 stores the compensation parameters in the memory 110.

When the output unit 117 reads the audio files from the memory 110 and outputs corresponding audio signals, the compensation unit 118 regulates the audio signals according to the compensation parameters, so as to approach or even attain the ideal outputs of the earphone 1, and transmits the regulated audio signals to the earphone 10 via the first USB interface 130. The earphone 10 receives the regulated audio signals via the USB interface 100. The D/A converter 109 converts the regulated audio signals into analog audio signals. The amplifier 120 amplifies the analog audio signals, and the sound output unit 101 transforms the analog audio signals into sounds, and outputs them.

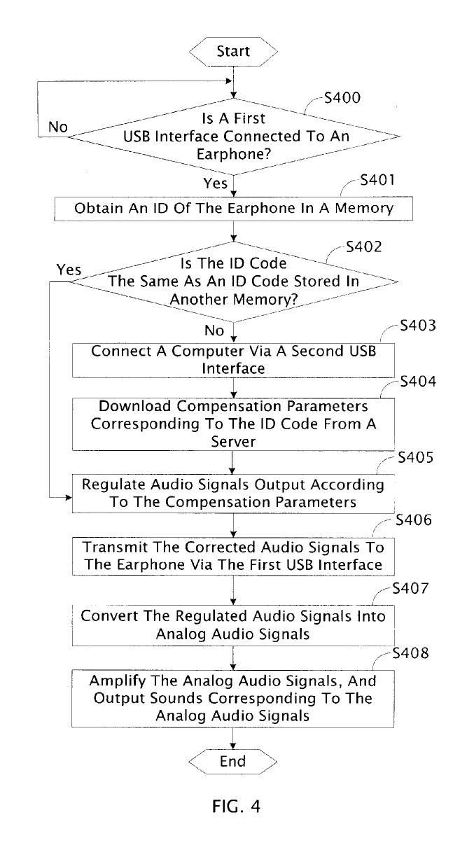

FIG. 4 is a flowchart of the second preferred sound output method by implementing the system of FIG. 3. In step S400, the detection unit 114 detects whether the first USB interface 130 is connected to an earphone 10. If the first USB interface 130 is not connected to an earphone 10, the procedure repeats step S400. Otherwise, in step S401, the compensation parameter obtaining module 115 obtains an ID code of the earphone 10 stored in the memory 102. In step S402, the micro-controller 111 determines whether the ID code is the same as the ID code stored in the memory 110. If the ID code is different from the ID code stored in the memory 110, in step S403, the compensation parameter obtaining module 115 connects to the computer 12 via the second USB interface 116. In step S404, the compensation parameter obtaining module 115 downloads the compensation parameters corresponding to the ID code from the server 12, the audio signal generating device 11 stores the ID code and the corresponding compensation parameters in the memory 110. In step S405, the compensation unit 118 regulates audio signals output by the output unit 117 according to the downloaded compensation parameters. In step S406, the compensation unit 118 transmits the regulated audio signals to the earphone 10 via the first USB interface 130, so as to approach or even attain the ideal output of the earphone 1. In step S407, the D/A converter 109 converts the regulated audio signals into the analog audio signals. In step S408, the amplifier 120 amplifies the analog audio signals, and the sound output unit 101 transforms the amplified analog audio signals into sounds, and outputs them.

In above-described step S402, if the ID code of the earphone 10 is the same as the ID code stored in the memory 110, the procedures directly goes to step S405 described above, the compensation unit 118 regulates audio signals output by the output unit 101 according to the stored compensation parameters, so as to approach or even attain ideal output of the earphone 1, and transmits the regulated audio signals to the earphone 10.

Although the present invention had been specifically described on the basis of the preferred embodiments including the preferred methods, the invention is not to be construed as being limited thereto. Various changes or modifications may be made to the embodiments including the methods without departing from the scope and spirit of the invention.

What is claimed is:

1. A sound output system comprising:
one or more sound output apparatuses, each sound output apparatus having been assigned an identification (ID) code;
a server for storing the ID code and corresponding compensation parameters for each sound output apparatus; and
an audio signal generating device, connected to the server through a network, for outputting audio signals, the audio signal generating device comprising:
a compensation parameter obtaining module for obtaining the ID code of the sound output apparatus if the sound output apparatus is connected to the audio signal generating device, and downloading compensation parameters corresponding to the ID code from the server; and
a compensation unit for regulating the audio signals according to the compensation parameters, and outputting the regulated audio signals to the sound output apparatus via an interface.

2. The sound output system according to claim 1, wherein the compensation parameters are built according to a real characteristic of the sound output apparatus.

3. The sound output system according to claim 2, wherein the compensation parameters comprise a frequency-efficiency compensation parameter and a frequency-phase delay compensation parameter respective for minimizing or even eliminating deviations of outputs of the sound output apparatus due to real characteristics of the sound output apparatus.

4. The sound output system according to claim 1, wherein the audio signal generating device converts the regulated audio signals into analog audio signals, and transmits the analog audio signals to the sound output apparatus if the interface is an analog interface.

5. The sound output system according to claim 1, wherein the audio signal generating device receives the ID code of the sound output apparatus from an input operation if the interface is an analog interface.

6. The sound output system according to claim 1, wherein the audio signal generating device directly transmits the regulated audio signals to the sound output apparatus if the interface is an universal serial bus (USB) interface.

7. The sound output system according to claim 6, wherein the sound output apparatus converts the regulated audio signals into analog audio signals, and outputting sounds corresponding to the analog audio signals.

8. The sound output system according to claim 1, wherein the ID code of the sound output apparatus is stored in the sound output apparatus if the interface is a USB interface.

9. A sound output method comprising the steps of:
providing one or more sound output apparatuses, an audio signal generating device for outputting audio signals, and a server;
obtaining an identification (ID) code of a sound output apparatus if the sound output apparatus is connected to the audio signal generating device, and downloading compensation parameters corresponding to the ID code from the server;
regulating audio signals according to the compensation parameters; and
outputting the regulated audio signals to the sound output apparatus via an interface.

10. The sound output method according to claim 9, wherein the compensation parameters comprise a frequency-efficiency compensation parameter and a frequency-phase delay compensation parameter for the sound output apparatus respective for minimizing or even eliminating deviations of outputs of the sound output apparatus due to real characteristics of the sound output apparatus.

11. The sound output method according to claim 9, further comprising the step of converting the regulated audio signals into analog audio signals, and transmitting the analog audio signals to the sound output apparatus if the interface is an analog interface.

12. The sound output method according to claim 9, further comprising the step of receiving the ID code of the sound output apparatus from an input operation if the interface is an analog interface.

13. The sound output method according to claim 9, further comprising the step of directly transmitting the regulated audio signals to the sound output apparatus if the interface is an universal serial bus (USB) interface.

14. The sound output method according to claim 13, further comprising the step of converting the regulated audio signals into analog audio signals, and outputting sounds corresponding to the analog audio signals.

15. The sound output method according to claim 9, wherein the ID code of the sound output apparatus is stored therein if the interface is a USB interface.

16. An audio signal generating device, connected to an external server through a network, for outputting audio signals, the audio signal generating device comprising:
a compensation parameter obtaining module for obtaining an identification (ID) code of an external sound output apparatus if the sound output apparatus is connected thereto, and downloading compensation parameters corresponding to the ID code from the server; and
a compensation unit for regulating the audio signals according to the compensation parameters, and outputting the regulated audio signals to the sound output apparatus via an interface.

17. The device according to claim 16, wherein the compensation parameters are built according to the real characteristic for the sound output apparatus.

18. The device according to claim 17, wherein the compensation parameters comprise a frequency-efficiency compensation parameter and a frequency-phase delay compensation parameter respective for minimizing or even eliminating deviations of outputs of the sound output apparatus due to real characteristics of the sound output apparatus.

19. The device according to claim 16, further comprising a digital/analog (D/A) for converting the regulated audio signals into analog audio signals, and transmitting the analog audio signals to the sound output apparatus if the interface is an analog interface.

20. The device according to claim 16, wherein the compensation unit directly transmits the regulated audio signals to the sound output apparatus if the interface is a universal serial bus (USB) interface.
